(19) United States
(12) Patent Application Publication
(10) Pub. No.: US 2009/0280262 A1
(43) Pub. Date: Nov. 12, 2009

(54) METHOD FOR FORMING COMPOSITE MEMBRANE WITH POROUS COATING LAYER AND APPARATUS THEREOF

(75) Inventors: KUO-LUN TUNG, Tao-Yuan (TW); CHI-CHUNG HSIUNG, Tao-Yuan (TW); TE-CHENG LING, Tao-Yuan (TW); KAI-SHIUN CHANG, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 12/117,287

(22) Filed: May 8, 2008

(51) Int. Cl. B05D 1/02

(52) U.S. Cl. 427/448; 118/47; 118/308

(57) ABSTRACT

The present invention discloses a method for forming a composite membrane with a porous coating layer. At first, a filling process is carried out to fill the pores of a porous substrate with a liquid. Next, a raw material is transformed into melt or incomplete melt droplets by a heating source and the droplets are sprayed to the surface of the porous substrate filled with the liquid. The liquid is evaporated by the high temperature droplets and plasma flame to become vapor and the vapor breaks through the droplets to have the droplets sputter into different blocks to thereby form random and dispersed flat particles after cooled. Flat particles are formed and stacked continuously so as to form a composite membrane with a porous coating layer. Moreover, the invention provides an apparatus for forming a composite membrane with a porous coating layer.

### BACKGROUND OF THE INVENTION

1. Field of the Invention

The present invention is generally related to a method for forming a composite membrane and an apparatus thereof, and more particularly to a method for forming a composite membrane with a porous coating layer and an apparatus thereof.

2. Description of the Prior Art

Membrane separation is energy-saving and economical separation technique. Thus, the membrane separation process has gradually become important in chemical industry, water treatment, food processing, biomedical technology, electronic industry, and so forth. In the membrane separation process, the material of membrane can be organic, inorganic, or organic/inorganic hybrid. Since inorganic material has the advantages of thermal stability, mechanical stability, and chemical stability, inorganic membrane has been widely applied in separation, either in micro filtration, ultra filtration, gas separation, or even in membrane reactor.

Inorganic membrane generally can be categorized into two types, dense membrane and porous membrane, according to the morphology of its surface. Since the porous membrane has higher permeability than the dense one, it has been widely applied in various industries. Besides, the porous membrane has more functionalities than the dense one and can be applied in gas separation, micro filtration and ultra filtration for solid-liquid separation, and even nano-filtration.

Among the methods for preparing porous inorganic membrane, methods like sol-gel method, solid particle sintering method, and chemical vapor deposition (CVD), etc., are common ones, but these processes have disadvantages of complicated processing, time consuming, limited selection in raw materials to limit the industrial application thereof. Therefore, in order to solve the above-mentioned problems, it is necessary to develop a new membrane apparatus and process to manufacture a composite membrane with a porous coating layer to reduce manufacturing cost.

### SUMMARY OF THE INVENTION

In light of the above background, in order to fulfill the requirements of the industry, the present invention provides a method for forming a composite membrane with a porous coating layer and an apparatus thereof so as to solve the above problems in the prior art.

One object of the present invention is to utilize the principle of liquid vaporization by heat to prepare a porous inorganic membrane. At first, melt droplets are sprayed to the surface of a porous substrate filled with a liquid. The liquid is evaporated by the high temperature droplets and plasma flame to become vapor and the vapor breaks through the droplets to have the droplets sputter into different blocks to thereby form random and dispersed flat particles after cooled. Flat particles are formed and stacked continuously so as to form a composite membrane with a porous coating layer.

Another object of the present invention is to use organic polymeric material and/or inorganic material to form an organic/inorganic coating layer. On the contrary, the prior techniques such as sol-gel method, solid particle sintering method, and chemical vapor deposition, are not feasible to prepare organic porous membranes or organic/inorganic composite membranes. Therefore, this present invention does have the economic advantages for industrial applications.

### DESCRIPTION OF THE PREFERRED EMBODIMENTS

What is probed into the invention is a method for forming a composite membrane with a porous coating layer and an apparatus thereof. Detail descriptions of the device and steps will be provided in the following in order to make the invention thoroughly understood. Obviously, the application of the invention is not confined to specific details familiar to those who are skilled in the art. On the other hand, the common steps or devices that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a first embodiment of the present invention, a method for forming a composite membrane with a porous coating layer is provided. At first, a porous substrate is provided. The porous substrate is ceramic or metallic porous substrate with a pore diameter less than or equal to 100 μm. A filling process to fill the pores of the porous substrate with a liquid is carried out. The liquid can be water, alcohol, ketone, or combination thereof. The filling process can be pressurized type filling, showering type filling, vacuum suction type filling, and dipping type filling. Following that, a melting process is performed to transform a raw material into melt or incomplete melt droplets by a heat source, such as flame, arc, or plasma. Then, spraying these droplets to the surface of the porous substrate filled with the liquid is performed to complete a spraying process. In the spraying process, these droplets impact the surface of the porous substrate and diffuse towards surroundings after colliding to form planarized droplets. The evaporation of the liquid is induced by these high temperature droplets and plasma flame (the temperature higher than the boiling point of the liquid) and then the liquid becomes vapor. The vapor breaks through the thinner portion of the planarized droplets to have the droplets sputter into different blocks to thereby form random and dispersed flat particles after cooled. By repeatedly performing the spraying process, flat particles are formed and stacked continuously so as to form a composite membrane with a porous coating layer. After the process of forming the composite membrane with a porous coating layer, the filling, melting, and spraying process can be performed to increase the thickness of the coating layer. In addition, the inorganic material comprises one material selected from the group consisting of the following or any combination thereof: alkali metal, alkaline earth metal, mixture of alkali and alkaline earth metal silicates, aluminum silicates, zirconium silicates, hydrated silicates, aluminates, oxides, nitrides, oxynitrides, carbides, oxycarbides, borates, titanates, phosphates, halides, and derivatives thereof. In a preferred example of this embodiment, the melting process and spraying process can be combined into a thermal spraying process or an atmospheric plasma spraying process.

In a second embodiment of the present invention, an apparatus for forming a composite membrane with a porous coating layer is disclosed. The apparatus comprises a heat source generating device, a raw material transporting device, a filling device, and spraying device. The raw material transporting device transports a raw material to the heat source generating device and the raw material is transformed into melt or incomplete melt droplets by a heat source, such as flame, arc, or plasma. Besides, the filling device is to fill the pores of a porous substrate with a liquid and the porous substrate is of ceramics or metal. The liquid can be water, alcohol, ketone, or mixture thereof. The spraying device sprays the droplets to the surface of the porous substrate filled with the liquid. The liquid is evaporated by the high temperature droplets and plasma flame (the temperature higher than the boiling point of the liquid) to become vapor and the vapor breaks through the droplets to have the droplets sputter into different blocks to thereby form random and dispersed flat particles after cooled. Flat particles are formed and stacked continuously so as to form a composite membrane with a porous coating layer. The filling device can be a pressurized type filling device, showering type filling device, vacuum suction type filling device, and dipping type filling device. In addition, the heat source generating device adjusts electric power supply and the temperature of a heat source according to a first signal, the raw material transporting device adjusts the speed of raw transportation according to a second signal, and the spraying device adjusts the speed of spraying according to a third signal. Besides, the first, second and third signals are generated by a control device.

In a third embodiment of the present invention, an apparatus used in an atmospheric plasma spraying process for forming a composite membrane with a porous coating layer is disclosed. The apparatus comprises a power generator, a high frequency generator, a plasma gun, a powder feeder, and a filling device. The high frequency generator uses supplied electric power to generate high frequency spark and ignite an arc. The arc energy is used by the plasma gun to ionized inert gas and to generate a plasma jet flow in the plasma gun. The powder feeder feeds a powder into the plasma gun and uses the temperature of the plasma jet flow to transform the powder into melt or incomplete melt droplets. The filling device is to fill the pores of a porous substrate with a liquid. The plasma jet flow sprays the droplets to the surface of the porous substrate filled with the liquid. The liquid is evaporated by the high temperature droplets and plasma flame (the temperature higher than the boiling point of the liquid) to become vapor and the vapor breaks through the droplets to have the droplets sputter into different blocks to thereby form random and dispersed flat particles after cooled. Flat particles are formed and stacked continuously so as to form a composite membrane with a porous coating layer. The material of the porous substrate, the liquid, and the filling device are in the same manner as those in the second embodiment. In addition, the power generator adjusts electric power supply according to a first signal, the high frequency generator adjusts start ignition according to a second signal, the plasma gun adjusts the speed of spraying according to a third signal, the powder feeder adjusts the speed of transporting powder according to a fourth signal, and besides the first, second, third, and fourth signals are generated by a control device.

The thermal spraying method is a new method for preparing membranes, generally for preparing dense inorganic membranes. The common atmospheric plasma spraying technique is a spraying process under atmosphere and the porosity of the thus formed coating layer is high. Therefore, the density of membrane by atmospheric plasma spraying is not higher enough for the users in applying protection coating by atmospheric plasma spraying. Thus, there are various processes developed in atmospheric plasma spraying technique. For a long time, such a characteristic, the coating layer with high porosity fabricated by atmospheric plasma spraying, that is thought to be failure, has not been applied in the method for preparing porous membranes. The invention conquers the technical bias by those who are skilled in the art and uses such discarded technique and improves it to achieve high porosity. Thus, the invention can not be easily achieved.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method for forming a composite membrane with a porous coating layer, comprising:
providing a porous substrate;
performing a filling process to fill the pores of said porous substrate with a liquid;
performing a melting process to use a heating source to transform a raw material into melt or incomplete melt droplets;
performing a spraying process for said porous substrate wherein said droplets impact the surface of said porous substrate and diffuse towards surroundings after colliding to form planarized droplets, said liquid is evaporated by said high temperature droplets and plasma flame to become vapor, the vapor breaks through the thinner portion of said planarized droplets to have said droplets sputter into different blocks to thereby form random and dispersed flat particles after cooled; and
repeatedly perform said spraying process to continue forming and stacking flat particles so as to form a composite membrane with a porous coating layer.

2. The method according to claim 1, wherein said filling process comprises one process selected from the group consisting of the following: pressurized type filling process, showering type filling process, vacuum suction type filling process, and dipping type filling process.

3. The method according to claim 1, wherein said porous substrate is of ceramics or metal.

4. The method according to claim 1, wherein said raw material is organic polymeric material and inorganic material.

5. The method according to claim 4, wherein said inorganic material comprises one material selected from the group consisting of the following or any combination thereof: alkali metal, alkaline earth metal, mixture of alkali and alkaline earth metal silicates, aluminum silicates, zirconium silicates, hydrated silicates, aluminates, oxides, nitrides, oxynitrides, carbides, oxycarbides, borates, titanates, phosphates, halides, and derivatives thereof.

6. The method according to claim 1, wherein the pore diameter of said porous substrate is less than or equal to 100 μm.

7. The method according to claim 1, wherein said liquid comprises one substance selected from the group consisting of the following or any combination thereof: water, alcohol, or ketone.

8. The method according to claim 1, wherein said heating source used in said melting process comprises one source selected from the group consisting of the following or any combination thereof: flame, arc, or plasma.

9. The method according to claim 1, wherein said melting process and said spraying process are combined to be a thermal spraying process.

10. The method according to claim 1, wherein said melting process and said spraying process are combined to be an atmospheric plasma spraying process.

11. The method according to claim 1, wherein said temperature of said droplets in said spraying process is higher than the boiling point of said liquid.

12. The method according to claim 1, wherein the thickness of said porous coating layer is less than or equal to 50 μm.

13. An apparatus for forming a composite membrane with a porous coating layer, comprising:
a heat source generating device;
a raw material transporting device to transport a raw material to said heat source generating device wherein said raw material is transformed into melt or incomplete melt droplets by a heat source;
a filling device to fill the pores of a porous substrate with a liquid; and
a spraying device to spray said droplets to the surface of said porous substrate wherein said liquid is evaporated by said high temperature droplets and plasma flame to become vapor, the vapor breaks through said droplets to have said droplets sputter into different blocks to thereby form random and dispersed flat particles after cooled, and flat particles are formed and stacked continuously so as to form a composite membrane with a porous coating layer.

14. The apparatus according to claim 13, wherein said heat source generating device adjusts electric power supply and the temperature of a heat source according to a first signal, said raw material transporting device adjusts the speed of raw transportation according to a second signal, said spraying device adjusts the speed of spraying according to a third signal, and besides said first signal, said second signal and said third signal are generated by a control device.

15. The apparatus according to claim 13, wherein said heating source generated by said heat source generating device comprises one source selected from the group consisting of the following or any combination thereof: flame, arc, or plasma.

16. The apparatus according to claim 13, wherein said porous substrate is of ceramics or metal.

17. The apparatus according to claim 13, wherein said liquid comprises one substance selected from the group consisting of the following or any combination thereof: water, alcohol, or ketone.

18. The apparatus according to claim 13, wherein said filling device comprises one device selected from the group consisting of the following: pressurized type filling device, showering type filling device, vacuum suction type filling device, and dipping type filling device.

19. The apparatus according to claim 13, wherein the temperature of said droplets is higher than the boiling point of said liquid.

20. An apparatus used in an atmospheric plasma spraying process for forming a composite membrane with a porous coating layer, comprising:
a power generator for supplying electric power;
a high frequency generator using said electric power to generate high frequency spark and ignite an arc;
a plasma gun using inert gas ionized by the energy of said arc to generate a plasma jet flow therein;
a powder feeder for feeding a powder into said plasma gun wherein said powder is transformed into melt or incomplete melt droplets via the temperature of said plasma jet flow; and
a filling device for filling the pores of a porous substrate with a liquid wherein said plasma jet flow sprays said droplets to the surface of said porous substrate filled with said liquid, said liquid is evaporated by said high temperature droplets and plasma flame to become vapor, the vapor breaks through said droplets to have said droplets sputter into different blocks to thereby form random and dispersed flat particles after cooled, and flat particles are formed and stacked continuously so as to form a composite membrane with a porous coating layer.

21. The apparatus according to claim 20, wherein said power generator adjusts electric power supply according to a first signal, said high frequency generator adjusts start ignition according to a second signal, said plasma gun adjusts the speed of spraying according to a third signal, said powder feeder adjusts the speed of transporting powder according to a fourth signal, and besides said first, second, third, and fourth signals are generated by a control device.

22. The apparatus according to claim 20, wherein said porous substrate is of ceramics or metal.

23. The apparatus according to claim 20, wherein said liquid comprises one substance selected from the group consisting of the following or any combination thereof: water, alcohol, or ketone.

24. The apparatus according to claim 20, wherein the temperature of said droplets is higher than the boiling point of said liquid.

25. The apparatus according to claim 20, wherein said filling device comprises one device selected from the group consisting of the following: pressurized type filling device, showering type filling device, vacuum suction type filling device, and dipping type filling device.
